(19) United States
(12) Patent Application Publication
(10) Pub. No.: US 2009/0060497 A1
(43) Pub. Date: Mar. 5, 2009

(54) Feedback Controlled Locking of Optical Channel Signals in Optical Receivers in Wavelength Division Multiplexed (WDM) Communication Systems

(76) Inventor: Winston I. Way, Irvine, CA (US)

Correspondence Address: FISH & RICHARDSON, PC, P.O. BOX 1022, MINNEAPOLIS, MN, 55440-1022, US

(21) Appl. No.: 12/203,080

(22) Filed: Sep. 2, 2008

Related U.S. Application Data
(60) Provisional application No. 60/969,101, filed on Aug. 30, 2007.

(51) Int. Cl. H04B 10/08

(52) U.S. Cl. 398/27

(57) ABSTRACT

Techniques, apparatus and systems for optical communications that use feedback controlled locking of optical channel signals in optical receivers in WDM communication systems, including ultra dense WDM systems.

### PRIORITY CLAIM

This document claims the benefit of U.S. Provisional Application No. 60/969,101 entitled “FEEDBACK CONTROLLED LOCKING OF OPTICAL FILTERS AND DEMULTIPLEXERS FOR OPTICAL RECEIVERS IN ULTRA-DENSE WDM SYSTEMS” and filed on Aug. 30, 2007, which is incorporated by reference as part of the disclosure of this document.

### BACKGROUND

This application relates to techniques, apparatus and systems for optical wavelength-division-multiplexed (WDM) communications.

Optical wavelength division multiplexing (WDM) can be used to use a single fiber to carry multiple optical channels at different WDM wavelengths. The frequency spacing between two adjacent WDM wavelengths, known as the channel spacing, can be reduced to increase the number of optical WDM channels carried by a fiber within a given spectral bandwidth. As the channel spacing reduces, it is desirable to tightly control the frequency spacing so that the optical cross talk between two adjacent WDM channels is below a threshold to maintain proper operation and performance of optical communications. For example, an ultra dense WDM system can have a small channel spacing of 12.5 GHz with a high baseband signal rate at approximately 10 Gbps. The small channel spacing and the high data rate can lead to optical interference between two adjacent optical WDM channels due to various factors, e.g., linear crosstalk at receiving-end optical filters and nonlinear optical effects in fibers. When different lasers are used to produce different optical WDM channels, such lasers can be stabilized in frequency against frequency drifts and fluctuations in the lasers to reduce optical interference. Because the channel spacing is close in ultra dense WDM systems, a laser frequency drift or fluctuation could cause degradation in the transmission signal.

### SUMMARY

This document provides examples of techniques, apparatus and systems for optical communications that use feedback controlled locking of optical channel signals in optical receivers in WDM communication systems, including ultra dense WDM systems.

In one aspect, a method for optical wavelength division multiplexed (WDM) communications includes using a tunable optical WDM demultiplexer to separate different optical WDM channels in a received WDM signal into different optical WDM channel signals; converting each optical WDM channel signal into an electronic WDM channel signal; processing each electronic WDM channel signal to measure a digital error count; and using the measured digital error counts from the electronic WDM channel signals as a feedback to control the tunable optical WDM demultiplexer to shift center frequencies of the WDM channels to minimize or reduce the measured digital error count in each electronic WDM channel signal.

In another aspect, a method for optical wavelength division multiplexed (WDM) communications includes using a tunable optical WDM demultiplexer to separate different optical WDM channels in a received WDM signal into different optical WDM channel signals; converting each optical WDM channel signal into an electronic WDM channel signal; processing each electronic WDM channel signal to measure a signal quality; and using the measured signal quality from the electronic WDM channel signals as a feedback to control the tunable optical WDM demultiplexer to shift center frequencies of the WDM channels to increase the measured signal quality in each electronic WDM channel signal.

In another aspect, a method for optical wavelength division multiplexed (WDM) communications includes separating a received WDM signal having different optical WDM channels into different optical signals along different optical paths, each carrying all the different optical WDM channels; using a tunable optical filter in each optical path to filter a respective optical signal to produce an optical WDM channel signal at a respective WDM optical frequency while rejecting light at other WDM optical frequencies; converting the optical WDM channel signal in each optical path into an electronic WDM channel signal; processing each electronic WDM channel signal to measure a digital error count; and using the measured digital error count from the electronic WDM channel signal as a feedback to control the tunable optical filter in each optical path to shift the center frequency of the tunable optical filter to minimize or reduce the measured digital error count in each electronic WDM channel signal.

In another aspect, a method for optical wavelength division multiplexed (WDM) communications includes separating a received WDM signal having different optical WDM channels into different optical signals along different optical paths, each carrying all the different optical WDM channels; using a tunable optical filter in each optical path to filter each optical signal to produce an optical WDM channel signal at a respective WDM optical frequency while rejecting light at other WDM optical frequencies; converting the optical WDM channel signal into an electronic WDM channel signal; processing each electronic WDM channel signal to measure a signal quality; and using the measured signal quality from the electronic WDM channel signal as a feedback to control the tunable optical filter in each optical path to shift the center frequency of the tunable optical filter to increase the measured signal quality in each electronic WDM channel signal.

In another aspect, an optical device for optical wavelength division multiplexed (WDM) communications includes an optical element that receives a WDM signal comprising different optical WDM channels at different optical wavelengths into different optical signals along different optical paths, each carrying all the different optical WDM channels; and receivers in the different optical paths, respectively, each receiver separating a respective optical WDM channel from other optical WDM channels and detecting the respective optical WDM channel. Each receiver includes a tunable optical filter in a respective optical path to filter a respective optical signal to produce an optical WDM channel signal at a respective optical wavelength while rejecting light at other optical wavelengths; an optical detector downstream from the tunable optical filter to convert the respective optical WDM channel signal into a respective electronic WDM channel signal; a processing circuit to receive and process the respective electronic WDM channel signal to measure a signal quality; and a feedback control circuit that produces a feedback control signal based on the measured signal quality to control the tunable optical filter in each optical path to shift the center frequency of the tunable optical filter to increase the measured signal quality in each electronic WDM channel signal.

In yet another aspect, an optical device for optical wavelength division multiplexed (WDM) communications includes a tunable optical WDM demultiplexer that receives a WDM signal comprising different optical WDM channels at different optical wavelengths and separates the received WDM signal into different optical WDM channels along different optical paths, the tunable optical WDM demultiplexer operable to tune a frequency of each optical WDM channel; and optical detectors in the different optical paths, respectively, each optical detector detecting a respective optical WDM channel to produce a respective electronic WDM channel signal; receiver circuits downstream from the optical detectors, respectively, wherein each receiver circuit operable to process a respective electronic WDM channel signal to measure a signal quality of the respective electronic WDM channel signal; and a feedback control circuit that produces a feedback control signal based on the measured signal quality of the electronic WDM channel signals from the receiver circuits to control the tunable optical WDM demultiplexer to shift a frequency of a respective optical WDM channel in each optical path to increase the measured signal quality in the respective electronic WDM channel signal.

These and other aspects and various examples and implementations are described in greater detail in the attached drawings, the description and the claims.

### BRIEF DESCRIPTION OF DRAWINGS

FIG. 1 illustrates an example of an optical WDM receiver with tunable optical filters and feedback control of the tunable optical filters.

FIGS. 2, 3, 4 and 5 show four example optical WDM transceivers based on feedback control of the tunable optical filters or tunable demultiplexers.

FIG. 6 shows an example of an optical comb generator that produces multiple WDM frequencies from a CW laser beam of a single laser for used in optical communication systems.

FIGS. 7A, 7B and 7C show an example for locking frequencies of different laser transmitters for producing different WDM channel signals based on a common wavelength locker for use in optical communication systems.

### DETAILED DESCRIPTION

WDM or ultra dense WDM systems can be designed to use multiple lasers to generate desired optical WDM frequencies with an even frequency spacing for optical WDM channels. Device aging, thermal fluctuations and other factors can cause the laser frequencies of the lasers to change and such changes can vary from laser to laser. Laser stabilization control may be implemented at each laser to stabilize the laser frequency in a synchronous manner. For example, all transmitter lasers in a WDM system can be frequency and/or phase-locked to a common wavelength locker to ensure the channel spacing is fixed so that all lasers drift together and maintain a fixed channel spacing.

In many ultra dense WDM systems, the frequency stability of transmitter lasers is usually very good and each transmitter laser tends to exhibit slight frequency shifts. Such slight frequency shifts can be tracked by the optical receiver to ensure that the full signal in each WDM channel is received by an optical detector for that WDM channel. In this regard, the receiver can include multiple tunable filters designated to filter light at different WDM channel frequencies that can be slightly tuned in frequency in order to track the slight frequency drifts at the transmitter side.

This tracking on the receiver side can be implemented in a feedback control within the receiver based on the digital bit error measured in each received optical WDM channel. A filter feedback control circuit is provided to control and tune each tunable optical filter located in front of an optical detector for a respective WDM channel and different filters have different feedback control circuits. Such a filter feedback control circuit receives information on the digital bit error measured in the received optical WDM channel and generates a filter control signal to its respective tunable optical filter to tune the center frequency of the filter to reduce the digital bit error.

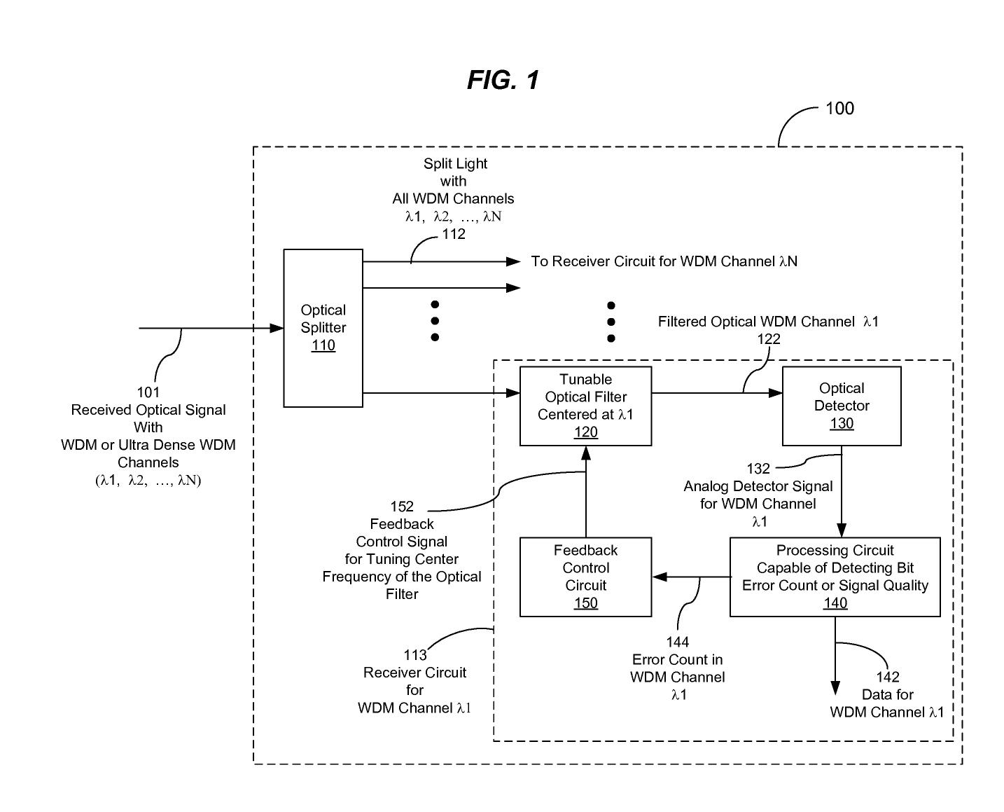

FIG. 1 illustrates one example of such a filter feedback control in a WDM receiver 100 in an optical network. In this example, the WDM receiver 100 receives from the optical network an optical WDM signal 101 that includes WDM channels λ1, λ2, . . . , and λN. The WDM receiver 100 includes an optical splitter or coupler 110 that splits the received optical WDM signal 101 into N substantially identical portions 112 along different optical paths and each portion 112 includes light in all WDM channels λ1, λ2, . . . , λN. Receiver circuit modules 113 are provided in the optical paths for the WDM channels λ1, λ2, . . . , λN, respectively. Details of the receive circuit module 113 for the WDM channel λ1 are illustrated as an example.

In each optical path, the receiver circuit module 113 includes a tunable optical filter 120 centered at a respective WDM wavelength, an optical detector, a processing circuit 140 and a feedback control circuit 150. The tunable optical filter 120 has a transmission band centered at a respective nominal WDM channel frequency and is used to selectively transmit light 122 at the respective WDM channel frequency within the bandwidth of the filter 120 and reject light at other wavelengths. The optical detector 130 is provided to receive the filtered optical output 122 for the WDM channel and covert the received light 122 into a detector signal 132 for the WDM channel.

As illustrated in FIG. 1 for the part of the receiver for the WDM channel λ1, the processing circuit 140 is provided to process the detector signal 132 for the WDM channel λ1 to measure the bit error or signal quality information (e.g., eye opening) in the received WDM channel λ1 and to produce an error signal 144 carrying the error count or signal quality information. The processing circuit 140 also extracts data from the detector signal 132 to generate a signal 142 carrying the data. A serializer-deserializer (SERDES) module may be placed between the optical detector 130 and the processing circuit 140 to format the data in the signal 132 in a form suitable for processing by the processing circuit 140. The filter feedback control circuit 150 is in communication with the processing circuit 140 to receive the measured error count or signal quality in the WDM channel and, based on the measured error count or signal quality, produces a filter feedback control signal 152 to the tunable optical filter 120 to tune the center frequency of the tunable optical filter 120 to minimize or substantially reduce the measured error count or to increase or maximize the signal quality. Hence, this filter feedback control uses a digital error-count signal or a quantitative eye-opening measurement in an eye diagram of a detected signal to produce an analog feedback control to the tunable optical filter 120. Therefore, the presence of the tunable optical filters 120 and the feedback control for tuning the tunable optical filters 120 renders the receiver 100 a tunable receiver which tracks each individual laser frequency drift or fluctuation.

The specific design of the processing circuit 140 and the feedback control circuit 150 can vary depending on the error correction encoding mechanisms in WDM systems. The processing circuit 140 in FIG. 1 is designed to provide information on digital error count or the digital signal quality of the digital WDM channel. The filter feedback control circuit 150 operates to control tuning of the center frequency of the tunable optical filter 120 for that WDM channel to minimize or substantially reduce the digital error count or to increase the digital signal quality. Examples of the error correction encoding mechanisms for WDM systems include forward error correction (FEC) and other digital signal quality measurements (e.g., digital eye opening in the eye diagram). The following sections use FEC as an example to illustrate implementation of the feedback control for each tunable optical filter 120 in FIG. 1.

An FEC technique adds redundant data to a data stream to be transmitted to allow packet losses to be repaired at the receiver without requiring either contact with the sender or retransmission of the lost data. The tunable receiver 100 shown in FIG. 1 can be implemented via an FEC circuit. When an optical transmitter frequency drifts slightly, the pre-FEC error count increases. The filter feedback control circuit 150 forms a FEC feedback control loop to tune an individual optical filter 120 to track the drift of the laser frequency and thus reduce the pre-FEC error count, e.g., recover the pre-FEC error rate back to its original value in absence of the laser frequency drift. In FIG. 1, the processing circuit 140 is configured to measure the pre-FEC error count and to perform the FEC operation on the digital data for the WDM channel. In the feedback control circuit 150, a dithering tone with an adjustable frequency, e.g., in the range of a few hundred Hertz to a few hundred Kilo-Hertz, can be applied to dither the center frequency of the tunable optical filter 120 slightly left or right to ensure the filter center frequency is maintained at a proper frequency position for the locking operation of the closed loop.

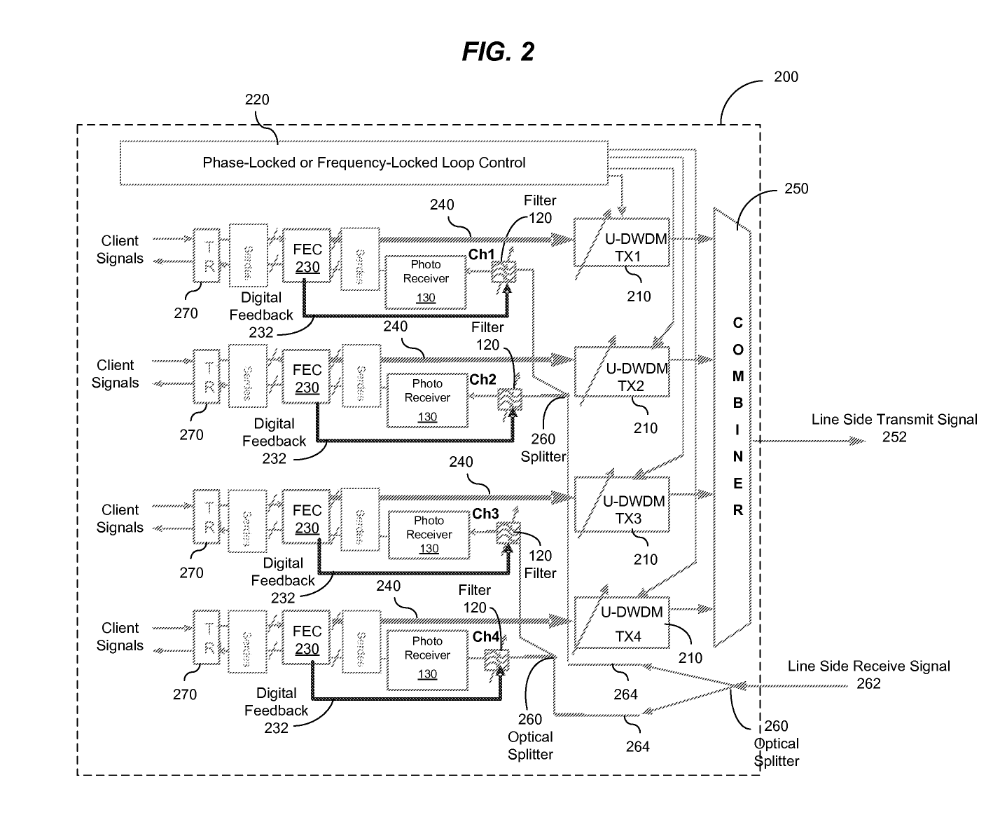

FIG. 2 shows an example of a WDM transceiver 200 based on the above exemplary FEC feedback control. Tunable transmitter lasers 210 (TX1, TX2, . . . , and TXN) are used to produce WDM signals at different WDM frequencies and are stabilized by a frequency locked loop and/or a phase locked loop 220. The loop 220, when implemented as a frequency-locked loop, is to ensure that all lasers 210 drift in the same direction synchronously so that the frequency spacing between any two neighbor lasers 210 can be maintained. The loop 220, when implemented as a phase-locked loop, is to control the phases of different WDM signals from different lasers 210 so that the orthogonal frequency division multiplexing (OFDM) condition can be satisfied. One example of the OFDM condition is described in Equation (1) in H. Sanjoh, et al, “Optical orthogonal frequency division multiplexing using frequency/time domain filtering for high spectral efficiency up to 1 bit/s/Hz”, Paper ThD1, Optical Fiber Communications Conference (OFC) 2002. An FEC circuit 230 is provided in each WDM channel path in producing an encoded data signal 240 for modulating a respective transmitter laser 210 in producing a WDM channel for transmission. In addition, the FEC circuit 230 also includes error detection circuitry for measuring the error count in received data before performing the FEC correction on the received data. An optical combiner 250, such as an optical WDM multiplexer or polarization combiner, is used to receive the optical WDM channel signals from different lasers 210 and to produce a line-side WDM signal 252 that carries the optical WDM channel signals.

The receiver part of the WDM transceiver 200 includes one or more optical splitters 260 to split the received line-side optical WDM signal 262 into optical signals 264 along different optical paths similar to the design in FIG. 1. Each optical path includes a tunable optical filter 120, a photo receiver 130 and the error detection circuitry of the FEC circuit 230 down stream from the photo receiver 130. An FEC feedback loop 232 is formed between the FEC circuit 230 and the tunable optical filter 120 to control the optical filter 120 to track a drift in the laser frequency. Electronic transceiver modules 270 are provided to interface with the client side equipment by sending and receiving electronic client side signals.

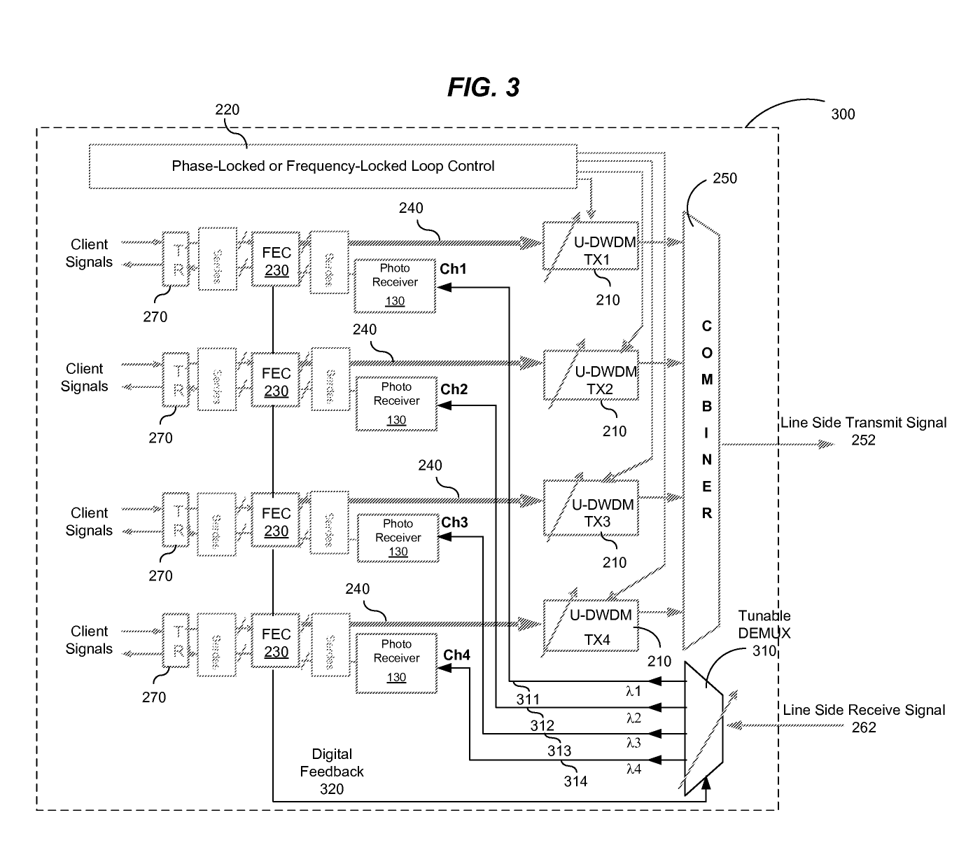

FIG. 3 shows another example transceiver 300 where a tunable WDM demultiplexer 310 is included in the receiver part of the transceiver 300 and is used to separate the received line side optical WDM signal 262 from the optical network into different optical WDM channel signals (e.g., 311, 312, 313 and 314) at different WDM wavelengths, respectively. Such a tunable demux 310 can tune center frequencies of all WDM channels inside demux together. Therefore, the tunable optical filters 120 in FIG. 2 are eliminated in the transceiver 300. The FEC circuits 230 in the signal paths of different WDM channels are used to produce the digital feedback signal 320 and a feedback control mechanism uses the FEC information in the digital feedback control signal 320 to control the tuning of the tunable demux 310 to reduce the received error and to improve the received signal quality. A pre-FEC value of the digital error count or digital eye opening of one WDM channel may be used to tune the tunable demux 310 to simultaneously adjust all WDM channels together to track the frequency drifts in the laser transmitters in the network that generate the received WDM signals. Alternatively, the averaged value for pre-FEC values of the error counts or eye openings of all WDM channels can be used for the feedback control to tune the tunable demux 310. In some implementations, the tuning algorithm may be based on error information in only one channel of the receive WDM channels and performs double checking on other WDM channels to ensure that the degraded pre-FEC value is caused by the laser transmitters and is not caused by some other transmission impairments in that particular channel.

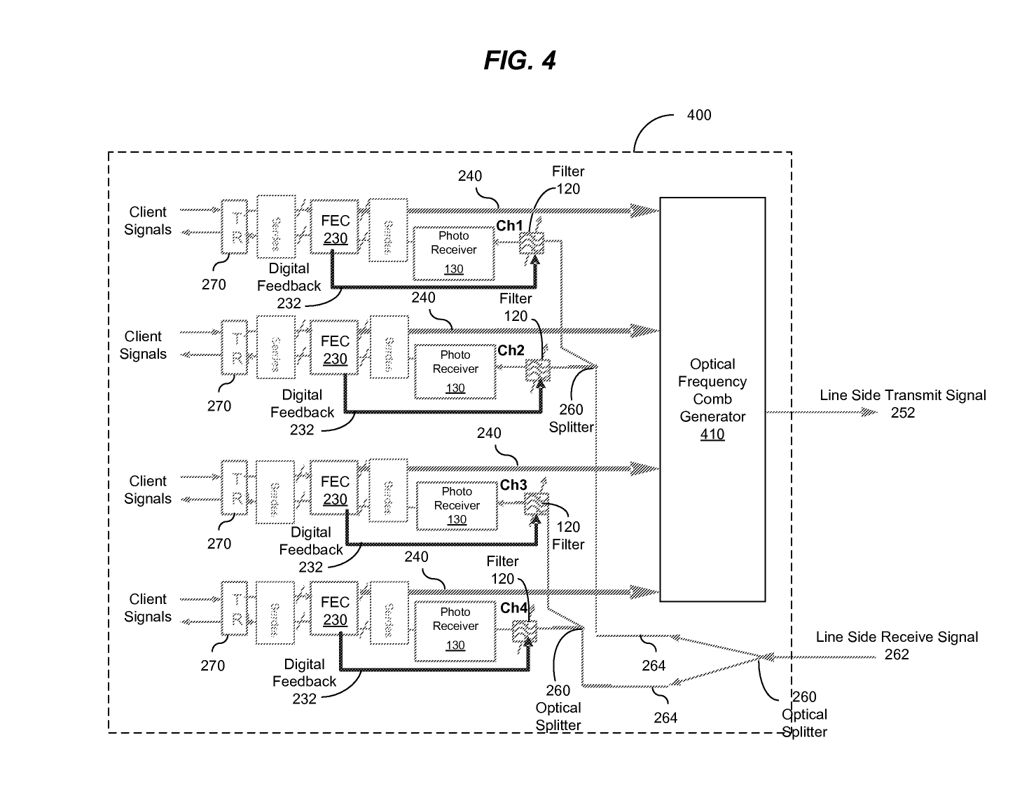

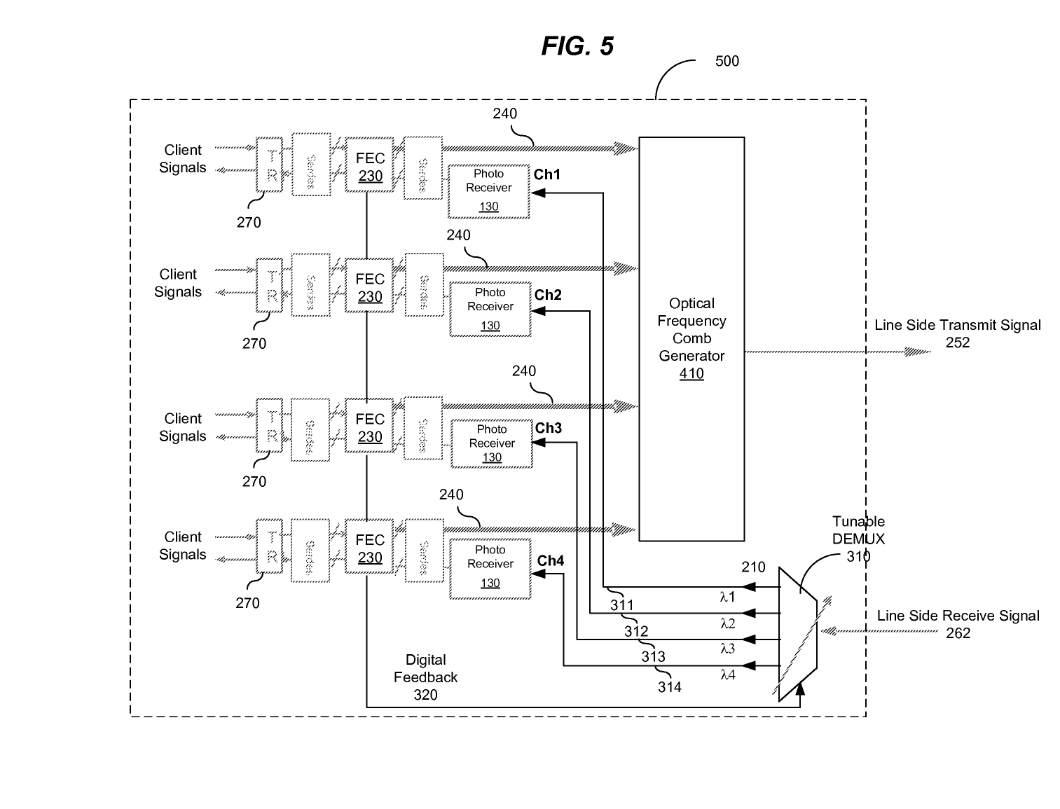

FIGS. 4 and 5 show WDM transceivers 400 and 500 that use a tunable optical frequency comb generator 410 to generate the different WDM channels for transmission. The tunable optical frequency comb generator 410 is designed to make all WDM frequencies move together and maintain a fixed channel spacing between two adjacent WDM channels. The feedback control mechanisms in FIGS. 4 and 5 are similar to the feedback controls in FIGS. 2 and 3, respectively.

The tunable optical frequency comb generator 410 can be in various configurations. For example, such a tunable optical frequency comb generator can use a single transmitter laser to generate desired optical WDM comb frequencies for WDM channels to provide tightly controlled frequency spacing between WDM channels. Aging and fluctuations at the single laser, although causing all optical WDM comb frequencies to change, cause all WDM channels to fluctuate in the same manner. Therefore, the frequency spacing between two adjacent WDM channels only changes slightly. Such designs that use a single laser to produce different WDM channel signals can be simple to implement at a relatively low cost and can achieve desired channel spacing control in closely spaced WDM channels at high data rates. In one implementation, for example, an optical frequency comb generator can include a single laser in a two-stage design where an optical modulation stage is provided to modulate a continuous wave (CW) signal from the single laser to produce desired optical sidebands at the optical WDM wavelengths with a desired spacing between two adjacent sidebands and a subsequent baseband modulation stage is used to modulate different optical beams at the different optical sidebands, respectively, to produce different optical WDM channel signals. Such optical WDM channel signals are combined at an optical combiner to produce the final optical WDM signal for transmission in a fiber link or fiber network. Other optical frequency comb generator designs can be used.

Examples of optical comb generators are described in U.S. patent application Ser. No. 12/175,439 entitled “Optical Wavelength-Division-Multiplexed (WDM) Comb Generator Using a Single Laser” and filed on Jul. 17, 2008, which is incorporated by reference as part of this document. An optical comb generator based on modulation of a CW laser beam from a single laser can use a subcarrier modulation technique in modulating the CW laser beam such as optical single sideband (OSSB) modulation or optical double sideband (ODSB) modulation.

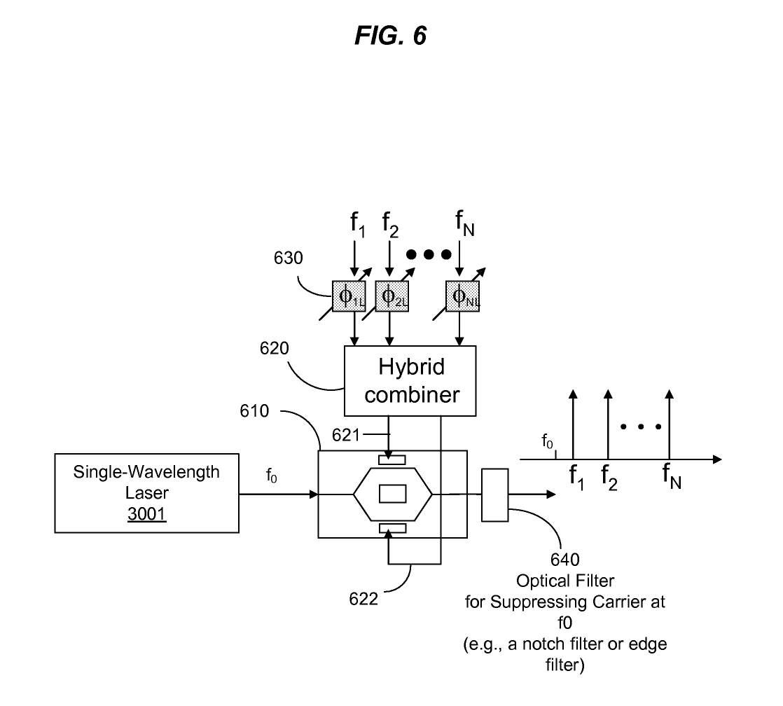

FIG. 6 shows an exemplary optical WDM comb generator based on OSSB modulation of a single laser to generate ultra dense optical comb carriers. Notably, the phase of each of the multiple comb carriers can be controlled in this comb generator and thus this provides an example of the phase-locked loop 220 in FIG. 2 for locking phases of different WDM signals in a situation where a single laser is used. In this example, the laser out at f0 from a laser 3001 is split into two optical branches of the MZI modulator 3010. The two optical branches are applied with, respectively, two microwave/millimeter-wave control signals 3021 and 3022 each carrying multiple microwave/millimeter-wave carriers f1, f2, . . . , fN. Under OSSB, the two microwave/millimeter-wave control signals 3021 and 3022 are phase shifted relative to each other by 90 degrees and the two optical branches are DC biased relative to each other by 90 degrees. A microwave/millimeter-wave hybrid signal combiner 3020 is provided to combine the multiple microwave/millimeter-wave carriers f1, f2, . . . , fN and to produce the two groups of microwave/millimeter-wave signals 3021 and 3022 with a relative phase shift of 90°. The two modulated optical carrier signals from the two optical branches can generate sidebands on one side of the optical carrier. In the example shown, the upper sidebands are preserved as the output optical carriers. The sidebands can also be evenly distributed on the two sides of the optical carrier f0. The spacing of the optical comb carriers are determined by the microwave/millimeter-wave carrier frequencies f1, f2, . . . , fN and the spacing between different adjacent carriers can be different depending on the values of the microwave/millimeter-wave carrier frequencies f1, f2, . . . , fN. This provides flexibility in generating desired comb frequency spacings.

In FIG. 6, adjustable microwave/millimeter-wave phase control units 3030 are provided in the signal paths of the multiple microwave/millimeter-wave carriers f1, f2, . . . , fN upstream from the microwave/millimeter-wave signal combiner 3020. Each microwave/millimeter-wave phase control unit 3030 can independently control the phase for a respective microwave/millimeter-wave carrier. Consequently, the phase values of the output comb carriers at f1, f2, . . . , fN can be individually controlled at desired values for specification applications. One application of such a comb generator for producing phase-controlled comb carriers, for example, is a transmitter for communications based on OFDM where two adjacent carriers are orthogonal to each other in phase. In various OFDM systems, the phase values of OFDM carriers are generated and controlled digitally, i.e., using DFT and IDFT. The device in FIG. 30 can be used to generate OFDM carriers in the analog domain, or analog OFDM. In the analog OFDM, the channel spacing between microwave/millimeter-wave carriers (and consequently the optical carriers) is set to be equal to the symbol rate, and the phase of each carrier is adjusted. This microwave/millimeter-wave phase control can be implemented in the above described line cards to improve the device performance

In addition to using a comb generator with a single laser source to guarantee the channel spacing between neighbor wavelengths, =multiple lasers can be used in combination with a highly precise wavelength locker to provide optical WDM signals for the optical transceivers in FIGS. 2 and 3.

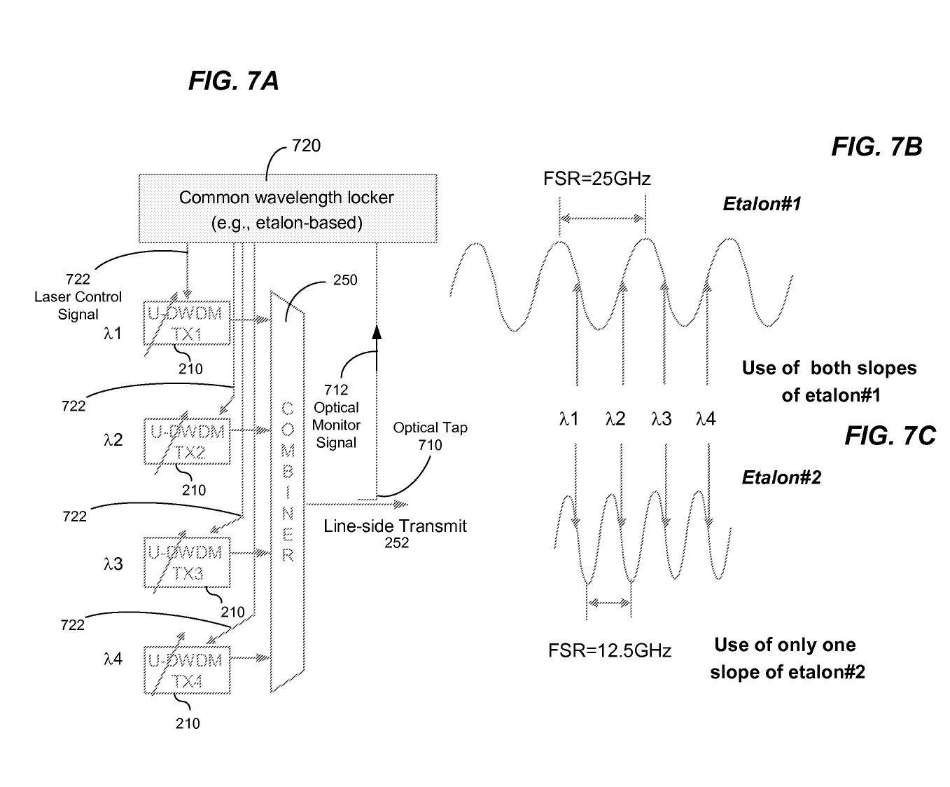

FIGS. 7A, 7B and 7C show an example for locking frequencies of different laser transmitters for producing different WDM channel signals based on a common wavelength locker. FIG. 7A shows the hardware associated with the frequency locking for the loop 220 in FIGS. 2 and 3 in which the combined optical power of all WDM channel wavelengths is tapped off after the wavelength multiplexer or combiner 250 by placing an optical tap 710 that splits a fraction of the total optical power as an optical monitor signal 712. The optical tap 710 can be an optical splitter such as a fiber coupler that splits power of all WDM wavelengths. A common wavelength locker 720 is provided to receive the optical monitor signal 712 from the optical tap 710. The wavelength locker 720 detects the wavelength error in each of the WDM wavelengths by using the optical monitor signal 712 and generates laser control signals 722 which are applied to the lasers 210, respectively, to tune the lasers 210 to reduce their respective wavelength errors.

The wavelength locker 720 can be implemented in various configuration, including Etalon-based designs. Examples of such wavelength lockers used for multiple wavelengths are described in, e.g., U.S. Pat. Nos. 6,369,923 and 6,845,109. The common wavelength locker ensures a highly precise wavelength spacing between neighbor channels produced by the lasers 210. For example, when a wavelength channel spacing of 12.5 GHz is required, an optical etalon with a free-spectral-range (FSR) of 25 GHz or 12.5 GHz may be used as shown in FIGS. 7B and 7C, respectively. In FIG. 7B, the two slopes of each resonance of the etalon with a free spectral range (FSR) of 25 GHz (twice the channel spacing) are used for locking two different lasers. In FIG. 7C, only one slope of each resonance of the etalon with a free spectral range (FSR) of 12.5 GHz (the same as the channel spacing) is used for locking a respective laser.

When a common wavelength locker with a highly precise FSR is used to guarantee the channel spacing between neighbor channels is a fixed number, all locked lasers 210 in FIG. 7A drift together as if they were generated from a single laser transmitter. At the receiver side, a single tunable demux (which also moves all optical filters at respective WDM channel wavelengths together) can be used to effectuate a single receiver tracking the frequency drift of a single transmitter. Again, the frequency tracking mechanism at the receiver side is to use the average and/or individual pre-FEC values of all 4 receivers.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. However, variations and enhancements of the described implementations and other implementations can be made based on what is described and illustrated.

What is claimed is what is described and illustrated, including:

1. A method for optical wavelength division multiplexed (WDM) communications, comprising:
using a tunable optical WDM demultiplexer to separate different optical WDM channels in a received WDM signal into different optical WDM channel signals;
converting each optical WDM channel signal into an electronic WDM channel signal;
processing each electronic WDM channel signal to measure a digital error count; and
using the measured digital error counts from the electronic WDM channel signals as a feedback to control the tunable optical WDM demultiplexer to shift center frequencies of the WDM channels to minimize or reduce the measured digital error count in each electronic WDM channel signal.

2. The method as in claim 1, comprising:
applying a forward error correction (FEC) processing to each electronic WDM channel signal to measure the digital error count in each electronic WDM channel signal.

3. The method as in claim 1, comprising:
using a plurality of millimeter or microwave carriers to modulate a single CW laser beam to produce the different optical WDM channels; and
controlling phase values of the millimeter or microwave carriers to achieve an optical orthogonal frequency division multiplexing condition in the different optical WDM channels.

4. The method as in claim 1, comprising:
using different lasers to produce the different optical WDM channels; and
using a common wavelength locker to lock the frequencies of the different lasers.

5. A method for optical wavelength division multiplexed (WDM) communications, comprising:
using a tunable optical WDM demultiplexer to separate different optical WDM channels in a received WDM signal into different optical WDM channel signals;
converting each optical WDM channel signal into an electronic WDM channel signal;
processing each electronic WDM channel signal to measure a signal quality; and
using the measured signal quality from the electronic WDM channel signals as a feedback to control the tunable optical WDM demultiplexer to shift center frequencies of the WDM channels to increase the measured signal quality in each electronic WDM channel signal.

6. The method as in claim 5, comprising:
applying a forward error correction (FEC) processing to each electronic WDM channel signal to measure the digital error count in each electronic WDM channel signal.

7. The method as in claim 5, comprising:
using a plurality of millimeter or microwave carriers to modulate a single CW laser beam to produce the different optical WDM channels; and
controlling phase values of the millimeter or microwave carriers to achieve an optical orthogonal frequency division multiplexing condition in the different optical WDM channels.

8. The method as in claim 5, comprising:
using different lasers to produce the different optical WDM channels; and
using a common wavelength locker to lock the frequencies of the different lasers.

9. A method for optical wavelength division multiplexed (WDM) communications, comprising:
separating a received WDM signal having different optical WDM channels into different optical signals along different optical paths, each carrying all the different optical WDM channels;
using a tunable optical filter in each optical path to filter a respective optical signal to produce an optical WDM channel signal at a respective WDM optical frequency while rejecting light at other WDM optical frequencies;
converting the optical WDM channel signal in each optical path into an electronic WDM channel signal;
processing each electronic WDM channel signal to measure a digital error count; and
using the measured digital error count from the electronic WDM channel signal as a feedback to control the tunable optical filter in each optical path to shift the center frequency of the tunable optical filter to minimize or reduce the measured digital error count in each electronic WDM channel signal.

10. The method as in claim 9, comprising:
applying a forward error correction (FEC) processing to each electronic WDM channel signal to measure the digital error count in each electronic WDM channel signal.

11. The method as in claim 9, comprising:
using a plurality of millimeter or microwave carriers to modulate a single CW laser beam to produce the different optical WDM channels; and
controlling phase values of the millimeter or microwave carriers to achieve an optical orthogonal frequency division multiplexing condition in the different optical WDM channels.

12. The method as in claim 9, comprising:
using different lasers to produce the different optical WDM channels; and
using a common wavelength locker to lock the frequencies of the different lasers.

13. A method for optical wavelength division multiplexed (WDM) communications, comprising:
separating a received WDM signal having different optical WDM channels into different optical signals along different optical paths, each carrying all the different optical WDM channels;
using a tunable optical filter in each optical path to filter each optical signal to produce an optical WDM channel signal at a respective WDM optical frequency while rejecting light at other WDM optical frequencies;
converting the optical WDM channel signal into an electronic WDM channel signal;
processing each electronic WDM channel signal to measure a signal quality; and
using the measured signal quality from the electronic WDM channel signal as a feedback to control the tunable optical filter in each optical path to shift the center frequency of the tunable optical filter to increase the measured signal quality in each electronic WDM channel signal.

14. The method as in claim 13, comprising:
applying a forward error correction (FEC) processing to each electronic WDM channel signal to measure the digital error count in each electronic WDM channel signal.

15. The method as in claim 13, comprising:
using a plurality of millimeter or microwave carriers to modulate a single CW laser beam to produce the different optical WDM channels; and
controlling phase values of the millimeter or microwave carriers to achieve an optical orthogonal frequency division multiplexing condition in the different optical WDM channels.

16. The method as in claim 13, comprising:
using different lasers to produce the different optical WDM channels; and
using a common wavelength locker to lock the frequencies of the different lasers.

17. An optical device for optical wavelength division multiplexed (WDM) communications, comprising:
an optical element that receives a WDM signal comprising different optical WDM channels at different optical wavelengths into different optical signals along different optical paths, each carrying all the different optical WDM channels; and
a plurality of receivers in the different optical paths, respectively, each receiver separating a respective optical WDM channel from other optical WDM channels and detecting the respective optical WDM channel,
wherein each receiver comprises:
a tunable optical filter in a respective optical path to filter a respective optical signal to produce an optical WDM channel signal at a respective optical wavelength while rejecting light at other optical wavelengths;
an optical detector downstream from the tunable optical filter to convert the respective optical WDM channel signal into a respective electronic WDM channel signal;
a processing circuit to receive and process the respective electronic WDM channel signal to measure a signal quality; and
a feedback control circuit that produces a feedback control signal based on the measured signal quality to control the tunable optical filter in each optical path to shift the center frequency of the tunable optical filter to increase the measured signal quality in each electronic WDM channel signal.

18. The device as in claim 17, wherein:
the signal quality is measured by a digital error count in the respective electronic WDM channel signal.

19. The device as in claim 17, wherein:
the signal quality is measured by a degree of an eye opening of an eye diagram for the respective electronic WDM channel signal.

20. The device as in claim 17, wherein:
the processing circuit applies a forward error correction (FEC) processing to the respective electronic WDM channel signal to measure a digital error count to represent the signal quality of the respective electronic WDM channel signal.

21. The device as in claim 17, comprising a transmitter module which comprises:
a single laser that produce a single CW laser beam;
an optical modulator that receives a plurality of millimeter or microwave carriers and modulates the single CW laser beam by using the millimeter or microwave carriers to produce different output optical WDM channels; and
an optical combiner that combines the different output optical WDM channels to produce an output WDM signal for transmission.

22. The device as in claim 21, wherein:
the transmitter module controls phase values of the millimeter or microwave carriers to achieve an optical orthogonal frequency division multiplexing condition in the different output optical WDM channels.

23. The device as in claim 17, comprising a transmitter module which comprises:
different lasers to produce different output optical WDM channels;
an optical combiner that combines the different output optical WDM channels to produce an output WDM signal for transmission;
an optical tap downstream from the optical combiner to split optical power of the output WDM signal to produce an optical monitor signal comprising light of the different output optical WDM channels; and
a common wavelength locker to receive the optical monitor signal, detect errors in frequencies of the different output optical WDM channels and to control frequencies of the different lasers to reduce the errors.

24. An optical device for optical wavelength division multiplexed (WDM) communications, comprising:
a tunable optical WDM demultiplexer that receives a WDM signal comprising different optical WDM channels at different optical wavelengths and separates the received WDM signal into different optical WDM channels along different optical paths, the tunable optical WDM demultiplexer operable to tune a frequency of each optical WDM channel; and
a plurality of optical detectors in the different optical paths, respectively, each optical detector detecting a respective optical WDM channel to produce a respective electronic WDM channel signal,
a plurality of receiver circuits downstream from the optical detectors, respectively, wherein each receiver circuit operable to process a respective electronic WDM channel signal to measure a signal quality of the respective electronic WDM channel signal; and
a feedback control circuit that produces a feedback control signal based on the measured signal quality of the electronic WDM channel signals from the receiver circuits to control the tunable optical WDM demultiplexer to shift a frequency of a respective optical WDM channel in each optical path to increase the measured signal quality in the respective electronic WDM channel signal.

25. The device as in claim 24, wherein:
the signal quality is measured by a digital error count in the respective electronic WDM channel signal.

26. The device as in claim 24, wherein:
the signal quality is measured by a degree of an eye opening of an eye diagram for the respective electronic WDM channel signal.

27. The device as in claim 24, wherein:
the processing circuit applies a forward error correction (FEC) processing to the respective electronic WDM channel signal to measure a digital error count to represent the signal quality of the respective electronic WDM channel signal.

28. The device as in claim 24, comprising a transmitter module which comprises:
a single laser that produce a single CW laser beam;
an optical modulator that receives a plurality of millimeter or microwave carriers and modulates the single CW laser beam by using the millimeter or microwave carriers to produce different output optical WDM channels; and
an optical combiner that combines the different output optical WDM channels to produce an output WDM signal for transmission.

29. The device as in claim 28, wherein:
the transmitter module controls phase values of the millimeter or microwave carriers to achieve an optical orthogonal frequency division multiplexing condition in the different output optical WDM channels.

30. The device as in claim 24, comprising a transmitter module which comprises:
different lasers to produce different output optical WDM channels;
an optical combiner that combines the different output optical WDM channels to produce an output WDM signal for transmission;
an optical tap downstream from the optical combiner to split optical power of the output WDM signal to produce an optical monitor signal comprising light of the different output optical WDM channels; and
a common wavelength locker to receive the optical monitor signal, detect errors in frequencies of the different output optical WDM channels and to control frequencies of the different lasers to reduce the errors.
